(19) United States
(12) Patent Application Publication
(10) Pub. No.: US 2026/0300994 A1
(43) Pub. Date: Oct. 1, 2026

(54) DIFFERENTIAL PRIVACY BASED RECURRENT NEURAL NETWORK POWERED STREAMLINE REGULATORY REPORTING PLATFORM FOR ENHANCED CUSTOMER ASSISTANCE

(71) Applicant: Bank of America Corporation, Charlotte, NC (US)

(72) Inventors: Saurabh Gupta, New Delhi (IN); Pallavi Goel, Uttar Pradesh (IN); Vijay Kumar Putcha, Telangana (IN)

(21) Appl. No.: 19/096,786

(22) Filed: Apr. 1, 2025

(51) Int. Cl. G06Q 30/018; G06F 21/62

(52) U.S. Cl. CPC G06Q 30/018; G06F 21/6245

(57) ABSTRACT

Apparatus and methods for automation of submission of a regulatory reporting form for a cross-border interaction between parties. A GPU is configured to run a differential privacy algorithm to add noise to the user's sensitive information, use this information to run an RNN to provide the user with the form to meet a regulatory reporting obligation for the cross-border interaction, and receive feedback from the user regarding the appropriateness of the form. The GPU is further configured, when the form is erroneous, to run a BPTT algorithm to revise the RNN and run it to provide another form. When the form is appropriate, or with the newly selected form, the GPU is configured to proceed to remove some of the added noise, run a Gen AI model to pre-populate the selected form to minimize opportunity for human error and subjectivity, and submit the pre-populated form to the appropriate regulatory authority.

### FIELD OF TECHNOLOGY

Aspects of this disclosure may relate to using a recurrent neural network to automatically provide a regulatory reporting filing for a cross-border interaction. Aspects of this disclosure may further relate to using generative artificial intelligence to pre-populate the selected regulatory reporting filing.

### BACKGROUND

The benefits of regulations may include safety, economic competitiveness, and/or environment. Safety may include patient safety, consumer protection, and/or worker safety. Economic competitiveness may include innovation, prices, and/or efficiency. Environment may include sustainable behavior and/or pollution.

Many sectors of commerce and economic endeavor are regulated. Industries may be regulated by government organizations, regulated by non-government organizations, self-regulated, and/or a combination of these.

Each region may have unique laws regarding the filing of regulatory reports. Regulatory reports may provide governing bodies with the opportunity to monitor entities and ensure compliance with regulations. Entities may attempt to follow the pertinent regulations but may be uncertain how to best do so. Each region may apply regulation concepts differently. Confusion about what local laws and rules governing the application of the regulations require may lead to errors as to which regulatory report to file. Mistakes may lead to legal issues and other ramifications.

Examples of industries that are regulated may include healthcare, banking, financial services, insurance, advertising, telecommunications, energy, construction, transportation, legal, food, agriculture, automotive, oil, and gas. Entities in the banking and/or financial services industries may include banks, broker-dealers, exchanges, clearing houses, clearing members, prime brokers and investment managers, swap data repositories or trade repositories and consolidated tape providers. Participants in any of these industries may need to meet regulatory reporting obligations by submitting appropriate filings. For example, when participants engage in cross-border interaction, they may initiate a need to make a regulatory reporting filing. Human errors and subjectivity may lead to submitting the wrong filings and/or populating the filings incorrectly. There is a need for systems and methods that minimize human errors and subjectivity in meeting regulatory reporting obligations.

Reporting regulations, such as transaction reporting regulations, may be common among developed and developing nations. Although the source of the reporting regulations may be similar, or sometimes the same, implementation may differ across various regions. Examples may include number of fields, time of reporting, type of reporting, penalty for non-compliance, and other aspects.

Multinational banks, for example, may operate in multiple regions each with its own regulatory authority. Multinational banks may need to tune their reporting architecture to comply with regional regulations that may be set by international regulatory bodies. It may be challenging for these organizations to stay up to date as reporting regulations undergo change and evolution. This challenge may be two-fold. The first challenge is meeting the current regulatory reporting obligations. The second challenge is keeping up with future regulatory reporting requirements.

There may be a need for a consistent and reliable way for an organization to meet its regulatory reporting requirements. There may be a need to reduce human error in making determinations about which regulatory report to file and how to populate fields within the report.

### SUMMARY

Provided are systems and methods for minimizing human errors and subjectivity in meeting regulatory reporting obligations. For example, disclosed may be a method automating submission of a regulatory reporting form to meet a regulatory reporting obligation for a cross-border interaction. Automation may reduce the number of manual steps which minimizes the opportunity for human error and subjectivity.

The method may include using a graphics processing unit (“GPU”) to receive a request from a user for a most suitable regulatory reporting form (“suggested form”) relating to a cross-border interaction. The cross-border interaction may include an interaction between the user and a second party that is facilitated by the organization. The user and the second party may be in separate regions governed by separate regulatory reporting obligations relating to the cross-border interaction. The suggested form may include a form that best meets the regulatory reporting obligation of the user from available regulatory reporting forms. The user's request for the most suitable regulatory reporting form may include a request to pre-populate the most suitable regulatory reporting form.

The GPU may receive sensitive information. The sensitive information may include information relating to the user, to a need of the user for the suggested form, and/or to a location of the user. The GPU may send one or more application programming interface (“API”) requests to API endpoints of one or more regulatory authorities from one or more regions. The one or more regulatory authorities may be selected by the GPU based on legal locations and/or the physical locations of the user and the second party at the time of the cross-border interaction between the user and the second party. The API requests may obtain current regulatory reporting forms and/or current rules relating to the current regulatory reporting forms.

The GPU may receive from one or more regulatory authorities in one or more regions, in response to API requests, current regulatory reporting forms and/or current rules relating to the current regulatory reporting forms that relate to the cross-border interaction between the user and the second party. The GPU may be used to run a differential privacy (“DP”) algorithm to add noise to the sensitive information. The noise may obscure the sensitive information. A metric for measuring how much the noise has obscured the sensitive information may include a predetermined privacy threshold. Successful obscuring of the data with noise may include the addition of noise to cause the data to exceed the predetermined privacy threshold exceeds while maintaining sufficient data structure within the sensitive information to facilitate data analysis.

The GPU may be used to run a recurrent neural network (“RNN”). The RNN may use the sensitive information with added noise to select a first regulatory authority and/or a first suggested form from the current regulatory reporting forms from the first regulatory authority. A first suggested form for reporting the cross-border interaction to the first regulatory authority may be identified. The GPU may run the RNN to minimize opportunity for human error and/or human subjectivity in selecting the first suggested form from the current regulatory reporting forms.

The GPU may provide the first suggested form from the current regulatory reporting forms to the user to score. The score may reflect an evaluation by the user as to a correctness of the selection of the first suggested form by the RNN. The GPU may receive a score from the user. The score may fall below a predetermined prediction threshold.

When the score falls below the predetermined prediction threshold, the GPU may run a backpropagation through time (“BPTT”) algorithm to adjust the RNN. The GPU may run a revised RNN, as adjusted by the BPTT, using the sensitive information with added noise, to select a second regulatory authority and/or a second suggested form from the current regulatory reporting forms from the second regulatory authority. The second suggested form may be used to report the cross-border interaction to the second regulatory authority. The GPU may run the revised RNN to minimize opportunity for human error and/or human subjectivity in selecting the second suggested form from the current regulatory reporting forms. The second regulatory authority may be different than the first regulatory authority. The second regulatory authority may be the same as the first regulatory authority.

The GPU may provide the second suggested form from the current regulatory reporting forms to the user to score. The score may reflect an evaluation by the user as to a correctness of the selection of the second suggested form by the revised RNN. The GPU may receive a score from the user that exceeds the predetermined prediction threshold.

The GPU may run the BPTT algorithm to selectively remove noise from the sensitive information to provide for more accurate data analysis, while maintaining enough noise to continue to exceed the predetermined privacy threshold.

The GPU may run a generative artificial intelligence (“Gen AI”) model to pre-populate the second suggested form. The GPU may run the Gen AI model to minimize opportunity for human error and/or human subjectivity when pre-populating the second suggested form.

The method may continue by submitting the second suggested form, as pre-populated, to the second regulatory authority. The submission of the second suggested form to the second regulatory authority may be performed by the user. The submission of the second suggested form to the second regulatory authority may be performed by the GPU. Sensitive information may aid in the determination of which regulatory authority governs the user during the interaction between the user and the second party.

In one aspect, the GPU may bypass the step of obtaining a score from the user. The GPU may proceed directly with the first suggested form from the current regulatory reporting forms to the step of selectively removing noise with the BPTT from the sensitive information to provide for more accurate data analysis, while maintaining enough noise to continue to exceed the predetermined privacy threshold. The GPU may run a Gen AI model to pre-populate the first suggested form. The GPU may run the Gen AI model to minimize opportunity for human error and/or human subjectivity when pre-populating the second suggested form.

The method may continue by submitting the first suggested form, as pre-populated, to the first regulatory authority. The submission of the first suggested form to the first regulatory authority may be performed by the user. The submission of the first suggested form to the first regulatory authority may be performed by the GPU.

The most suitable regulatory reporting form may reflect the current regulations for a region in which the user is located. The one or more regulatory authorities may be selected by the GPU based on the legal location of the user and/or the second party. The legal location of the user may include the user's domicile at the time of the cross-border interaction with the second party. The legal location of the second party may include the second party's domicile at the time of the cross-border interaction with the user. The legal location of the user may be under a different regulatory authority than the legal location of the second party.

The one or more regulatory authorities may be selected by the GPU based on the legal location of the user and/or the second party. The legal location of the user may include the user's domicile at the time of the cross-border interaction with the second party. The legal location of the second party may include the second party's domicile at the time of the cross-border interaction with the user. The legal location of the user may be under a different regulatory authority than the legal location of the second party.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative block diagram in accordance with the principles of the disclosure;

FIG. 2 shows an illustrative block diagram in accordance with the principles of the disclosure;

FIG. 3 shows an illustrative table in accordance with the principles of the disclosure;

FIG. 4 shows an illustrative block diagram in accordance with the principles of the disclosure;

FIG. 5 shows an illustrative block diagram in accordance with the principles of the disclosure;

FIG. 6A shows an illustrative flow diagram in accordance with the principles of the disclosure;

FIG. 6B shows an illustrative flow diagram in accordance with the principles of the disclosure;

FIG. 6C shows an illustrative flow diagram in accordance with the principles of the disclosure;

FIG. 7 shows an illustrative block diagram in accordance with the principles of the disclosure; and

FIG. 8 shows an illustrative block diagram in accordance with the principles of the disclosure.

### DETAILED DESCRIPTION

An organization and/or a user of products and services provided by the organization may incur a need to submit a filing to meet a regulatory reporting obligation. The organization may establish a repository to help identify a filing to meet the regulatory reporting obligation. Regulatory reporting obligations may arise due to activity in a regulated industry. The obligation may be incurred in any regulated region throughout the world.

There may be a need for a consistent and reliable way for an organization to meet their regulatory reporting requirements. There may be a need to reduce human error in making determinations about which regulatory report to file and how to populate fields within the report.

Existing systems and methods for submitting regulatory reports may be completely or mostly manual. Existing systems and methods may rely upon human discretion and judgement to determine which regulatory report to submit and how to populate the regulatory report. This approach may lead to human error, for example, in making mistakes in determining which form to file and/or in populating the form. Human errors may result in the organization and/or user not fully disclosing pertinent information. Human errors may also include mistakes in interpretation. Misinterpretation may be made by a user and lead the user to a wrong conclusion about which document to submit and what information to include.

This disclosure may provide a solution for a consistent and reliable way for an organization and/or a user to meet their regulatory reporting requirements in whatever region of the world they are located. This disclosure may further provide a solution to reduce human error in determining which regulatory report to file for a particular geographic region and how to populate fields within the regulatory report.

This disclosure may provide systems and methods that include an intelligent solution that uses differential privacy (“DP”) and a RNN to provide automated regulatory report selection for submission to a regional regulatory authority. This disclosure may further provide systems and methods that include Gen AI to automatically pre-populate a chosen regulatory report before submission. This disclosure may include determination of the region in which an organization needs to submit a regulatory report. This disclosure may include determination of which regulatory report to file in that respective region. This disclosure may automatically populate the selected regulatory report. This disclosure may automatically submit the regulatory report to the regulatory authority. Alternatively, the intelligent solution may first provide the completed regulatory report to the user for approval. After receiving approval, the intelligent solution may then submit the regulatory report. Alternatively, the user may submit the regulatory report after approving it.

In one aspect, this disclosure may provide systems and methods for using differential privacy (“DP”) and RNN to provide an automated approach for the organization, including members of the organization, to access current regulatory reporting updates in the field in which the organization operates. Access to current regulatory reporting updates may help the organization and their members to stay up to date with regulations affecting their day-to-day business and thereby may increase their operational efficiency and/or the organization's adherence to relevant regulations that govern the organization.

Provided are systems and methods for minimizing human errors and subjectivity in meeting regulatory reporting obligations. For example, disclosed may be a system for automation of submission of a regulatory reporting form to meet a regulatory reporting obligation for a cross-border interaction. Automation may reduce the number of manual steps which may minimize the opportunity for human error and subjectivity.

The system may include a graphics processing unit (“GPU”). The system may include an RNN. The system may include a Gen AI model.

The GPU may be configured to receive a request to an organization from a user for a most suitable regulatory reporting form (“suggested form”) relating to a cross-border interaction. The cross-border interaction may include an interaction between the user and a second party that is facilitated by the organization. The user and the second party may be in separate regions governed by separate regulatory reporting obligations relating to the cross-border interaction. The suggested form may include a form that best meets the regulatory reporting obligation from the regulatory reporting forms available. The user's request for the most suitable regulatory reporting form may include a request to pre-populate the most suitable regulatory reporting form.

The GPU may be configured to receive sensitive information. The sensitive information may include information relating to the user, to a need of the user for the suggested form, and/or to a location of the user. The GPU may be configured to send one or more application programming interface (“API”) requests to API endpoints of one or more regulatory authorities from one or more regions. The one or more regulatory authorities may be selected by the GPU based on legal locations and/or the physical locations of the user and the second party at the time of the cross-border interaction between the user and the second party. The API requests may obtain current regulatory reporting forms and/or current rules relating to the current regulatory reporting forms.

The GPU may be configured to receive from multiple regulatory authorities in multiple regions, in response to API requests, current regulatory reporting forms and/or current rules relating to the current regulatory reporting forms that relate to the cross-border interaction between the user and the second party. The GPU may be configured to run a differential privacy (“DP”) algorithm to add noise to the sensitive information. The noise may obscure the sensitive information. A metric for measuring how much the noise has obscured the sensitive information may include a predetermined privacy threshold. Successful obscuring of the data with noise may include the addition of noise to cause the data to exceed the predetermined privacy threshold while maintaining sufficient data structure within the sensitive information to facilitate data analysis.

The GPU may be configured to run an RNN. The RNN may use the sensitive information with added noise to select a first regulatory authority and/or a first suggested form from the current regulatory reporting forms from the first regulatory authority. A first suggested form for reporting the cross-border interaction to the first regulatory authority may be identified. The GPU may run the RNN to minimize opportunity for human error and/or human subjectivity in selecting the first suggested form from the current regulatory reporting forms.

The GPU may be configured to provide the first suggested form from the current regulatory reporting forms to the user to score. The score may reflect an evaluation by the user as to a correctness of the selection of the first suggested form by the RNN. The GPU may be configured to receive a score from the user. The score may fall below the predetermined prediction threshold.

When the score falls below the predetermined prediction threshold, the GPU may be configured to run a BPTT algorithm to adjust the RNN. The GPU may be configured to run a revised RNN, as adjusted by the BPTT, using the sensitive information with added noise, to select a second regulatory authority and/or a second suggested form from the current regulatory reporting forms from the second regulatory authority. The second suggested form may be used to report the cross-border interaction to the second regulatory authority. The GPU may be configured to run the revised RNN to minimize opportunity for human error and/or human subjectivity in selecting the second suggested form from the current regulatory reporting forms. The second regulatory authority may be the same regulatory authority as the first regulatory authority. The second regulatory authority may be a different regulatory authority than the first regulatory authority.

The GPU may be configured to provide the second suggested form from the current regulatory reporting forms to the user to score. The score may reflect an evaluation by the user as to a correctness of the selection of the second suggested form by the revised RNN. The GPU may receive a score from the user that exceeds the predetermined prediction threshold.

The GPU may be configured to run the BPTT algorithm to selectively remove noise from the sensitive information to provide for more accurate data analysis, while maintaining enough noise to continue to exceed the predetermined privacy threshold. The GPU may be configured to run the Gen AI model to pre-populate the second suggested form. The GPU may run the Gen AI model to minimize opportunity for human error and/or human subjectivity when pre-populating the second suggested form.

The method may be configured to submit the second suggested form, as pre-populated, to the second regulatory authority. The submission of the second suggested form to the second regulatory authority may be performed by the user. The submission of the second suggested form to the second regulatory authority may be performed by the GPU. The sensitive information may aid in determining which regulatory authority governs the user during the interaction between the user and the second party.

In one aspect, the GPU may be configured to bypass the step of obtaining a score from the user. The GPU may be configured to proceed directly with the first suggested form from the current regulatory reporting forms to the step of selectively removing noise with the BPTT from the sensitive information to provide for more accurate data analysis, while maintaining enough noise to continue to exceed the predetermined privacy threshold. The GPU may be configured to run a Gen AI model to pre-populate the first suggested form. The GPU may be configured to run the Gen AI model to minimize opportunity for human error and/or human subjectivity when pre-populating the second suggested form. The system may be configured to continue with the submission of the first suggested form, as pre-populated, to the first regulatory authority. The system may be configured for the submission of the first suggested form to the first regulatory authority to be performed by the user. The system may be configured for the submission of the first suggested form to the first regulatory authority to be performed by the GPU.

The most suitable regulatory reporting form may reflect the current regulations for a region in which the user is located. One or more regulatory authorities may be selected by the GPU based on the legal locations of the user and/or the second party. The legal location of the user may include the user's domicile at the time of the cross-border interaction with the second party. The legal location of the second party may include the second party's domicile at the time of the cross-border interaction with the user. The legal location of the user may be under a different regulatory authority than the legal location of the second party.

The one or more regulatory authorities may be selected by the GPU based on the legal locations of the user and/or the second party. The legal location of the user may include the user's domicile at the time of the cross-border interaction with the second party. The legal location of the second party may include the second party's domicile at the time of the cross-border interaction with the user. The legal location of the user may be under a different regulatory authority than the legal location of the second party.

The systems and methods described herein are illustrative. Systems and methods in accordance with this disclosure will now be described in connection with the figures, which form a part hereof. The figures show illustrative features of systems and methods in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments, such as systems and/or methods, may omit steps shown and/or described in connection with illustrative methods.

Embodiments may include steps that are neither shown nor described in connection with illustrative methods.

Illustrative method steps may be combined. For example, an illustrative method may include steps shown in connection with another illustrative method.

Systems may omit features shown or described in connection with illustrative systems. Embodiments may include features that are neither shown nor described in connection with the illustrative systems. Features of illustrative systems may be combined. For example, an illustrative embodiment may include features shown in connection with another illustrative embodiment.

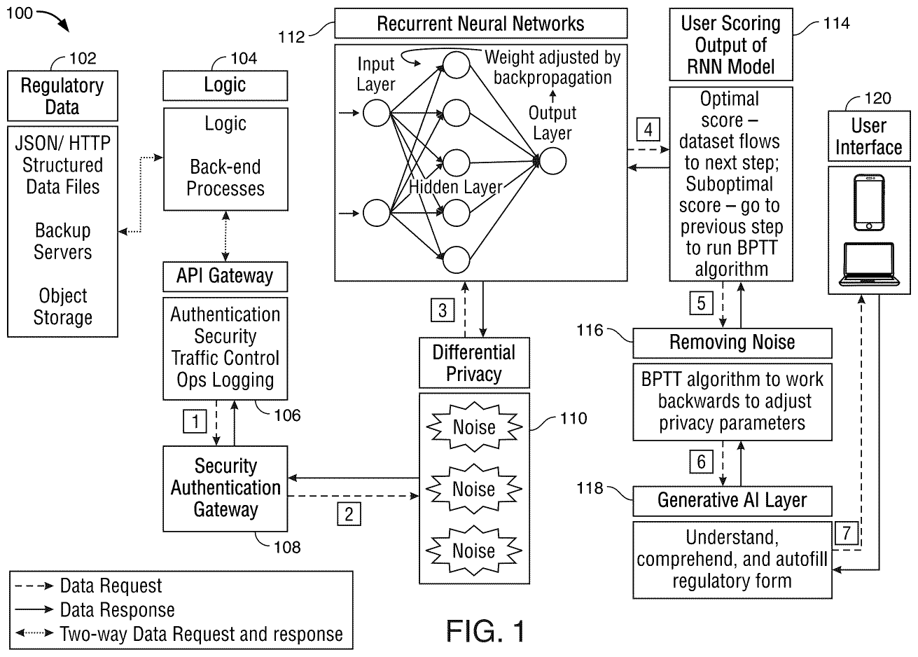

FIG. 1 shows an illustrative block diagram 100 in accordance with the principles of the disclosure. Block diagram 100 may include a flow illustrating a way for an organization to stay up to date on regulatory report obligations in cross-border interactions. Block diagram 100 may show a reporting framework to aggregate regulation reporting forms.

Step 1 in block diagram 100 may include gathering regulatory reporting forms. A GPU may be used to aggregate regulation reporting forms from various regulatory bodies around the world. The GPU may use API requests. Regulatory data 102 may be gathered using API requests. An API may serve as a bridge between systems and facilitate seamless interaction with data across diverse platforms. Data interactions may include actively engaging with a dataset by manipulating, analyzing, visualizing, and interpreting the dataset. The goal of the data interactions may be to extract insights and to explore relationships and patterns within the data.

Through APIs, such as API Gateway 106, systems may obtain regulatory data 102. API Gateway 106 may obtain regulatory data 102 by executing hypertext transfer protocol (“HTTP”) requests to retrieve information from various regulatory web servers, and leverage endpoints to access specific datasets. The datasets may include current regulations and regulatory updates in the field in which the organization operates. The HTTP request may provide a way for a user to affect a website to provide information. The HTTP request may include a message sent from a client such as a web browser to a server to ask for a specific resource on the internet such as a webpage, image, or file. HTTP may provide a way for the user to communicate a request and receive a response from the server. The endpoints may include a specific digital location, such as a uniform resource locator (“URL”) , where an API can send requests to access data or perform actions on a server. The endpoint may serve as a point of contact where an API receives calls and delivers responses. The endpoint may serve as a door to access resources within the API.

The GPU may use logic. Logic 104 may be utilized in the back-end processing to parse JSON or XML responses, extracting relevant datasets, and subsequently store them in a tech-enabled repository such as a database. Relevant datasets may include current regulations and regulatory updates in the field in which the organization or entity operates. A JSON response may include a payload returned by a web service from a request. JSON may include an open standard file format and data interchange format. JSON may use human-readable text to store and transmit data objects that include name-value pairs and arrays. JSON may be used, for example, with web applications and servers. Security authentication gateway 108 may be used to authenticate the current regulatory report forms and/or current rules received by API gateway 106.

Step 2 in block diagram 100 may include the GPU contacting security authentication gateway 108 to add noise through differential privacy (“DP”) 110. DP may inject controlled noise into datasets to protect sensitive information while preserving statistical accuracy. The sensitive information may include current regulations and regulatory updates in the field in which the organization operates. The disclosed DP-based solution may obscure sensitive information without compromising the overall utility of dataset and thereby not significantly impact the outcome of a query. This DP-based statistical technique may rely on precise parameters, such as privacy budget and sensitivity to calibrate the level of noise added. Calibrating the amount of noise added may ensure a balance between privacy protection and data utility. Privacy budget may refer to a finite resource that controls how much a user's privacy is sacrificed when analyzing a dataset. The privacy budget may be quantified by epsilon. A lower epsilon may mean higher privacy, and a higher epsilon may mean lower privacy. There may be an inverse relationship between protecting a user's privacy and providing accurate statistical analysis. Privacy budget may control a trade-off between privacy and accuracy in statistical analysis. This disclosure may seek to find an optimal balance between accuracy and privacy for an organization seeking to determine which regulatory report to file, such as which region's regulatory report to use and what entries to enter the chosen regulatory report.

Sensitivity may refer to the maximum change in a function's output when a single data point in the input is altered. Sensitivity may reflect an independent concept from sensitive information, and sensitive information may reflect an independent concept from sensitivity. Calibrating the level of added noise based on this sensitivity may be crucial to achieve the desired privacy level while still maintaining useful information from the data analysis. The more sensitive a function may indicate the more noise that is needed to be added to ensure privacy. Sensitivity may provide a way to quantify and decide how much noise to add to achieve the desired privacy level. Minimizing the addition of noise to only that which is necessary may be important as a dataset's predictive power may decrease with increasing noise. Laplace noise, a common method for adding noise, may be used when implementing differential privacy. The scale of the noise may be directly proportional to the sensitivity of the function.

Adding Laplace noise equal to the sensitivity of the average function may be necessary to achieve a desired level of privacy. Adding Laplace noise that is greater than the sensitivity of the average function may increase sensitivity but decrease a dataset's predictive power. Adding Laplace noise that is less than the sensitivity of the average function may decrease sensitivity but increase a dataset's predictive power. Adding noise such as Laplace noise to the RNN that incorporates DP may provide an optimal balance between accuracy and privacy for an organization seeking to determine which regulatory report to file, such as which region's regulatory report to use and what entries to enter into the chosen regulatory report.

In DP, noise may be added to a dataset by sampling random values from a specific probability distribution and then adding those values to the actual dataset. For example, the Laplace distribution may be used as the probability distribution. Adding this noise may obscure individual data points while still allowing for meaningful statistical analysis. In this disclosure, the amount of noise added may be calculated based on the privacy budget in order to control the level of privacy protection desired.

There may be a tradeoff between privacy of the dataset and accuracy of analysis performed with the dataset. As the noise is added to the dataset increases, accuracy of the analysis may decrease.

Step 3 in block diagram 100 may include the GPU providing the sensitive information with added noise to RNN 112. RNN 112 may process the sensitive information, provided to RNN 112 after noise was added through DP, by propagating information through nodes which may maintain internal state. Each node may store and update a hidden representation of data, allowing temporal dependencies to be captured. Temporal dependencies may include a relationship of how past events impact future states within a sequence of time. Input data may be fed into the network, and connections between nodes will enable information flow across time steps. RNN 112 may provide the best solution integrating regulations, geography, and product. RNN 112 may arrive at a best solution by applying an optimum permutation and combination from nodes.

In RNNs, a vanishing gradient may refer to a problem where the gradients used to update weights during backpropagation become extremely small as they propagate through a deep neural network. Small gradient may effectively prevent the network from learning effectively in the earlier layers of the neural network due to minimal weight updates. This problem may lead to poor training performance. RNNs may utilize gating mechanisms such as LSTM (Long Short-term Memory) and GRU (Gated recurrent unit) cells, to control the flow of information and mitigate vanishing gradient issues.

Gating mechanisms, such as within architectures like LSTM and GRU networks, may mitigate vanishing gradient issues by selectively controlling the flow of information through the network, allowing gradients to persist over longer sequences and preventing them from becoming too small during backpropagation. LSTM and GRU cells may be the individual building blocks of an LSTM and GRU network, respectively. An LSTM network may be made up of multiple LSTM cells and a GRU network may be made up of multiple GRU cells. Each cell may be designed to manage information flow within a sequence of data by utilizing gates to control what information is stored and passed on through time steps.

Step 4 in block diagram 100 may include the GPU providing a user with an opportunity to score 114 output of RNN 112. If the user is satisfied with the output of the RNN model and provides a score that exceeds a first pre-determined approval threshold, then the process may continue to the next step, which may include noise removal. The process may include transmitting the data that makes up the sensitive information with added noise to the next step. Providing a score of the output of the RNN model that exceeds the first pre-determined approval threshold may indicate the user's satisfaction with the output of the RNN model. The user's satisfaction with the output of the RNN may include where the metrics the user is seeking are provided with confidence level that exceeds a first pre-determined threshold. The next step of the process may include removing noise 116 to obtain metrics with an even high degree of confidence.

If the user is not satisfied with the output of RNN 112 and provides a suboptimal score, then the system and process may go back to RNN 112. The BPTT algorithm may be leveraged to determine the gradients. The principles of BPTT may allow a model to be trained by back calculating errors from the output layer to the input layer. These error calculations may help RNN 112 adjust and fit the parameters of the model appropriately.

The BPTT algorithm may be trained specifically for RNNs where it allows the network to learn from sequential data by “unfolding” the network across time steps. By doing so, the BPTT may create multiple copies of the network, each representing a different point in time. The BPTT may then backpropagate the error through all the time steps to update the network's weights and enable the network to learn temporal dependencies within the data.

To evaluate performance of the trained RNN model, one may use evaluation metrics such as Mean Absolute Error (MAE), Root Mean Squared Error (RMSE), and Mean Absolute Percentage Error (MAPE). The metrics may quantify the accuracy of the predictions compared to the actual values and provide valuable insights into the model's effectiveness.

Step 5 in block diagram 100 may include the GPU selectively removing noise 116 from the sensitive information. Once the score provided in step 4 exceeds the first pre-determined approval threshold, a BPTT algorithm may work backwards to compute metrics that the organization and/or user are seeking with a confidence level that exceeds a second pre-determined approval threshold. The second pre-determined approval threshold may be a higher approval threshold than the first pre-determined approval threshold.

The BPTT algorithm may include one or more post-processing steps. Post-processing may apply statistical techniques to the dataset to increase the confidence level of the output of RNN 112. Statistical techniques may include, for example, data averaging and/or data smoothing to refine noisy data and recover underlying signal.

RNN 112 may perform data averaging by incorporating temporal averaging. Temporal averaging may be achieved by using the internal memory of RNN 112 to consider previous data points within a sequence. Using previous data points within the sequence may function to capture trends and patterns over time without a need to calculate a traditional average. This may allow RNN 112 to make predictions based on the context of the sequence rather than just individual data points. Data averaging with RNN 112 may include sequential data processing that may contain an internal averaging effect. Data averaging with RNN 112 may achieve time series forecasting, anomaly detection, and/or signal smoothing.

RNN 112 may incorporate data smoothing for time series analysis. Data smoothing may include the application of statistical techniques like moving averages or exponential smoothing to the data before feeding it into RNN 112.

Preprocessing the data with data smoothing may help to remove noise and highlight underlying trends. £ Removing noise and highlighting trends may make it easier for RNN 112 to learn patterns and make accurate predictions. Data smoothing in RNN 112 may include simple moving average, exponential smoothing, and/or seasonality decomposition. Data smoothing may improve RNN 112 accuracy and/or may enhance interpretability.

RNN 112 may have its parameters tuned by adjust privacy parameters like epsilon to balance privacy and accuracy trade-offs. The tuning may reduce noise while maintaining privacy guarantees. The BPTT algorithm may work backwards to adjust privacy parameters like epsilon to balance privacy and accuracy trade-offs.

Step 6 in block diagram 100 may include the GPU running Gen AI layer 118. Gen AI layer 118 may enable understanding, comprehension, and auto filling of regulatory forms. The enhanced insights gathered from the previous step once RNN 112 is increased in accuracy by reducing the privacy budget may increase accuracy of Gen AI layer 118 in pre-populating the regulatory reporting filing. Gen AI may employ RNNs and/or various other learning approaches to discern patterns and structures within the data, which may then be used to create fresh content, translate content, among other things.

Step 7 in block diagram 100 may include GPU sending the pre-populated regulatory reporting filing to a user via user interface 120. When there is a need for approval by the user before submitting the populated regulatory reporting filing, such as when there is a regulatory requirement that the user approve the submission, then this step may be implemented. When there is not a need for customer approval for the submission, then GenAI layer 118 in the previous step may automatically submit the regulatory document to the proper regulatory authorities.

User Interface 120 may include a portal. The core functionality of the portal, which may be visible to the user, may host features such as optimized queries, lazy loading, representational state transfer (“REST”) APIS, analytics, and dashboards, and natural language processing (NLP) based Solr® search. Optimized queries may include database queries that have been carefully designed and structured to execute as efficiently as possible. Lazy loading may include a web development technique where certain elements of a webpage, like images or videos, are only loaded when they become visible to the user as they scroll, instead of loading everything on the page at once. REST APIs may allow applications to communicate with each other by using standard HTTP methods like GET, POST, PUT, and DELETE to access and manipulate data through well-defined endpoints. Solr® search may use NLP to achieve a fast, full text searching across large datasets.

This process may be a self-learning and evolving timestamp-based cache mechanism which may be learned from previous queries raised by the user. The process may be learned from search history, geographical location, device details, frequently searched for product, internal downloads, and/or previous learnings. These may contribute and combine to decide the final intent of a search to be referenced from the dynamic analog cache here. The cache mechanism may include a system where frequently accessed data is temporarily stored in a high-speed storage location, which may allow for faster retrieval and reduced workload on the primary data source.

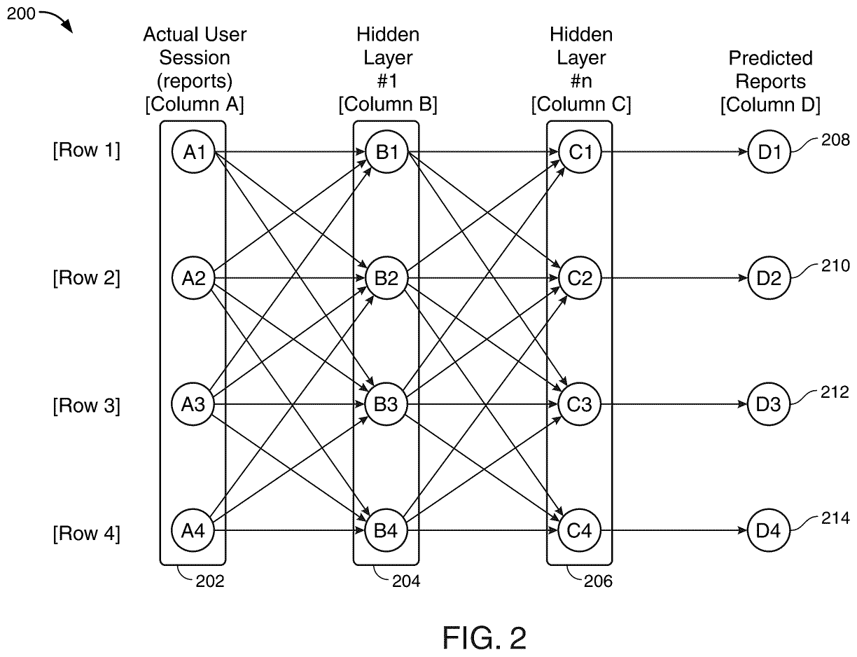

FIG. 2 shows an illustrative block diagram 200 in accordance with the principles of the disclosure. Block diagram 200 may include an illustrative diagram of an RNN.

The RNN may process sequential data. Sequential data may include sensitive information. The sensitive information may first have noise added to it through DP. The RNN may process sequential data by propagating user information through nodes of the RNN. The nodes may maintain an internal state.

Each node may store and update a hidden representation of data, which may allow temporal dependencies to be captured. Input data may be fed into the network.

Connections between nodes may enable information to flow across time steps.

The RNN may provide a best solution to the issue of determining a selected regulatory reporting filing. The RNN may integrate regulations, geography, and products the user information may pertain to as factors to determining the best solution. The RNN may achieve this goal by applying optimum permutations and combinations from the nodes. The RNN may utilize a gating mechanism such as LSTM and/or GRU cells to control the flow of information and to mitigate vanishing gradient issues.

Column A 202 may illustrate data from actual user sessions such as A1, A2, A3, and A4 for Row 1, Row 2, Row 3, and Row 4, respectively. Column B 204 may illustrate data from a first hidden layer such as B1, B2, B3, and B4. Column C 206 may illustrate data from a nth hidden layer such as C1, C2, C3, and C4. Column D may illustrate predicted reports such as regulatory reporting filings. Rows 1-4 show four predicted reports, D1 208, D2 210, D3 212, and D4 214.

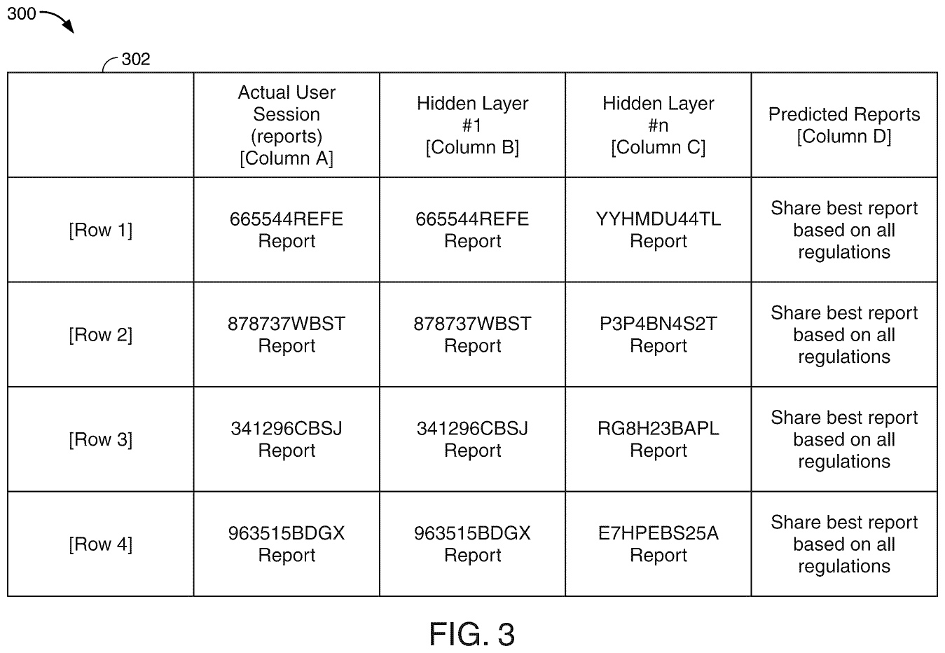

FIG. 3 shows an illustrative table 300 in accordance with the principles of the disclosure. Table 302 may contain four columns and four rows. Columns and rows in the Table 302 may correlate to the columns and tables in the illustrative block diagram 200 in FIG. 2. Column A of the RNN may reflect reports from actual user sessions. Rows 1-4 may reflect four different user sessions. Column B may reflect a first hidden layer. Rows 1-4 may reflect multiple nodes in the first hidden layer. Column C may reflect “n” hidden layer. There may be multiple hidden layers, even as many as dozens, hundreds, or thousands of hidden layers in the RNN. Rows 1-4 may reflect multiple nodes in the “n” hidden layer. Column D may reflect predicted reports from the use of the RNN. Rows 1-4 may reflect best guesses for regulatory reporting files based on the user inputs in Column A and the RNN calculations in Column B and Column C.

Table 302 may show sequential data. Column A may show data from four actual user sessions reports, as shown in rows 1-4. The sequential data may be fed into the first hidden layer of the RNN in Column B. Noise may be added to the sequential data using DP. Column C may show an nth hidden layer. Column D may show predicted reports as shared by the RNN based on all regulations accumulated. The RNN may process sequential data (provided after adding noise through DP) by propagating information through nodes which will maintain an internal state.

Each node in the RNN may store and update a hidden representation of data, allowing temporal dependencies to be captured. Input data may be fed into the network, and connections between nodes may enable information flow across time steps. The RNN may provide a best solution based on the sensitive information that the RNN may further integrate with regulations, geography, sample cross-border interactions, and details about an anticipated cross-border interaction between a user and a second party. The RNN may apply optimum permutation and combination from nodes. The RNN may utilize gating a mechanism such as LSTM or GRU cells, to control the flow of information and mitigate vanishing gradient issues.

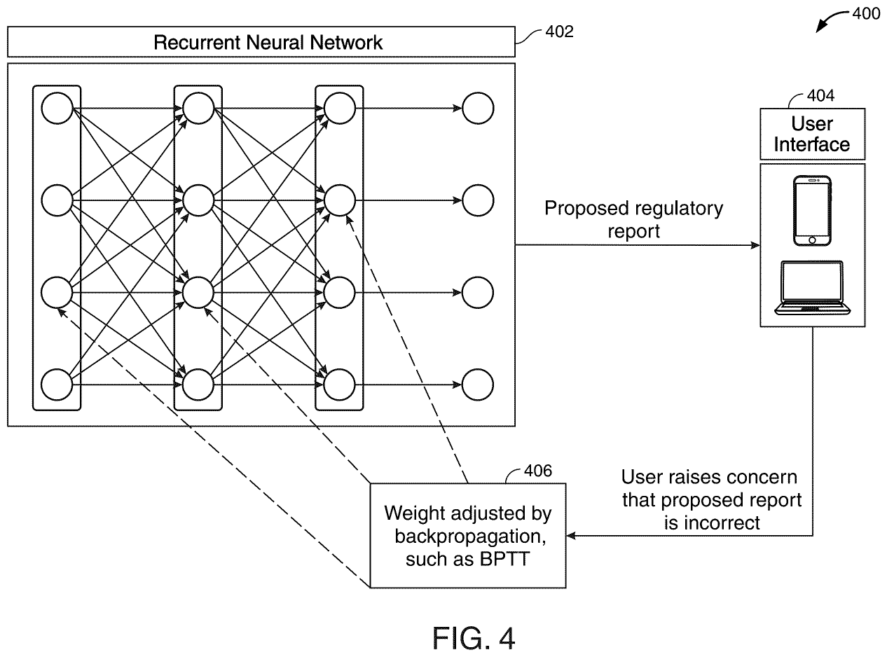

FIG. 4 shows an illustrative block diagram 400 in accordance with the principles of the disclosure. RNN 402 may recommend a proposed regulatory report to user interface 404. The user on user interface 404 may raise a concern, such as by providing a suboptimal score, that the proposed report is incorrect. The user's feedback may result in a weight adjustment by backpropagation, such as by BPTT 406. Weight adjusted by backpropagation such as BPTT 406 may adjust the weights in RNN 402. The revised RNN may make another proposed regulatory report to user interface 404. This time, the user on user interface 404 may indicate that the proposed report is correct by giving an optimal score. In such an outcome, the block diagram may move onto removing noise in the sensitive information to help increase the data quality accessible to RNN 402 and to a Gen AI model that pre-populates the selected regulatory report filing.

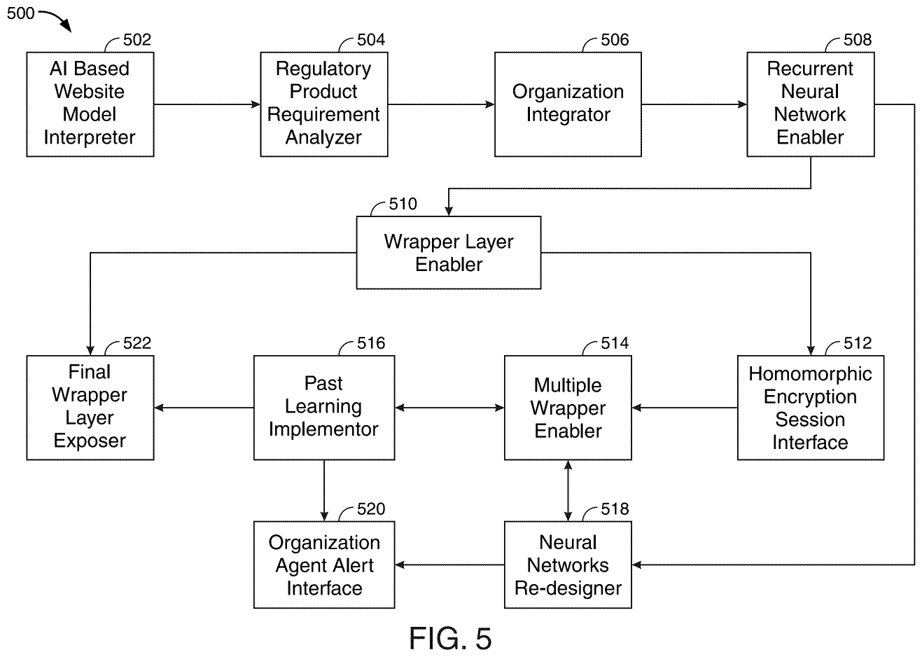

FIG. 5 shows an illustrative block diagram 500 in accordance with the principles of the disclosure. Block diagram 500 may show an architecture diagram. The architecture may begin with AI based website model interpreter 502. The architecture may continue with regulatory product requirement analyzer 504. The next step may be organization integrator 506. The architecture may continue with recurrent neural network enabler 508. The next step may be neural network re-designer 518 or the wrapper layer enabler 510. When the next step is neural network re-designer 518, the architecture may continue with multiple wrapper enabler 514 or organization agent alert interface 520. When the next step is organization agent alert interface 520, the process may end. When the next step is multiple wrapper enabler 514, see below for multiple wrapper enabler 514 for continuation of the flow.

When the next step after recurrent neural network enabler 508 is wrapper layer enabler 510, the next step may be final wrapper layer exposer 522 which may be the end of the flow, or homomorphic encryption session interface 512. Homomorphic encryption session interface 512 may continue with the multiple wrapper enabler 514. Multiple wrapper enabler 514 may continue with past learning implementor 516 or neural network re-designer 518. Neural network re-designer 518 may end with organization agent alert interface 520. Past learning implementor 516 may continue and conclude with either final wrapper layer exposer 522 or organization agent alert interface 520.

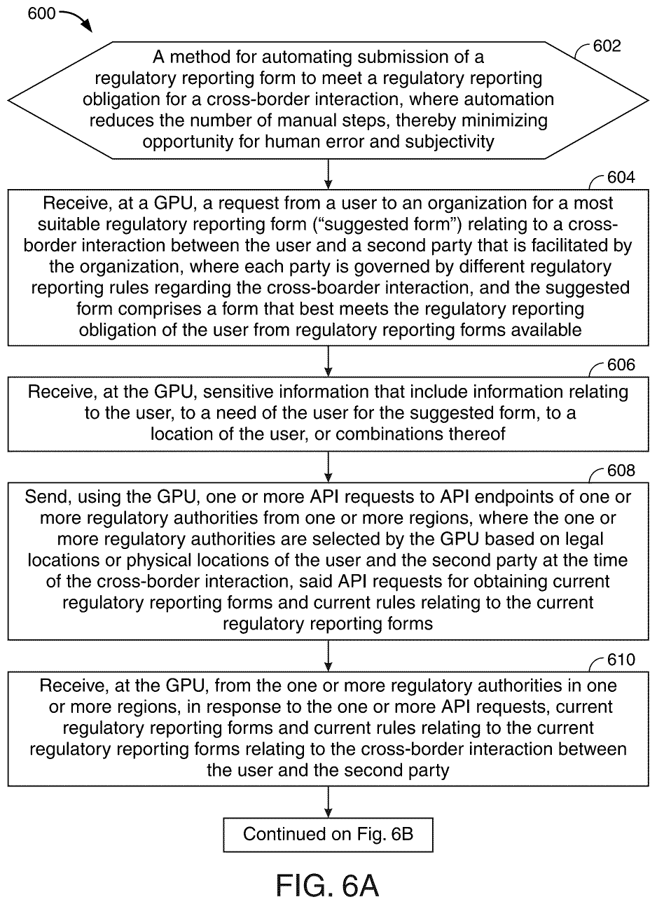

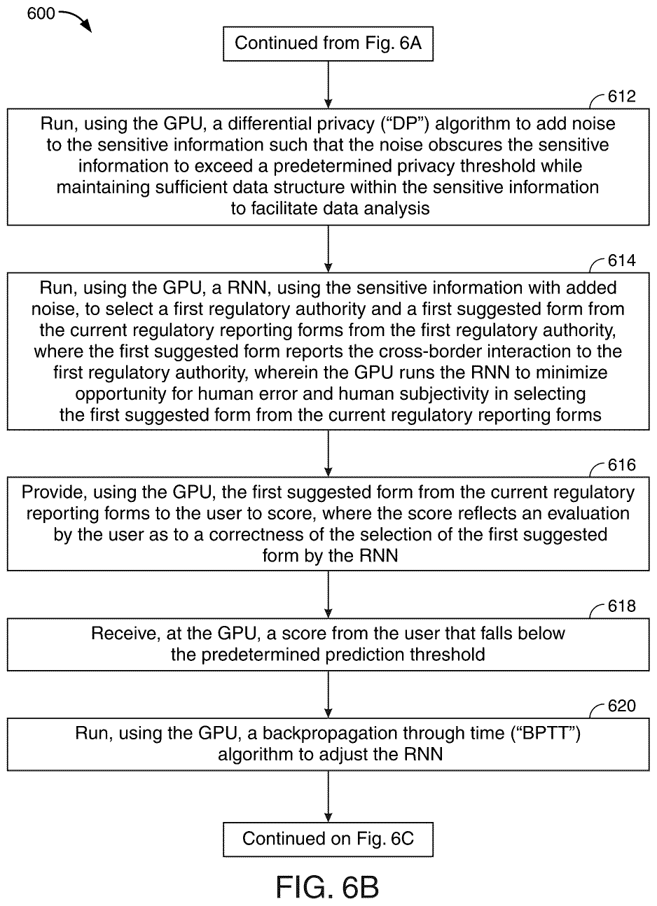

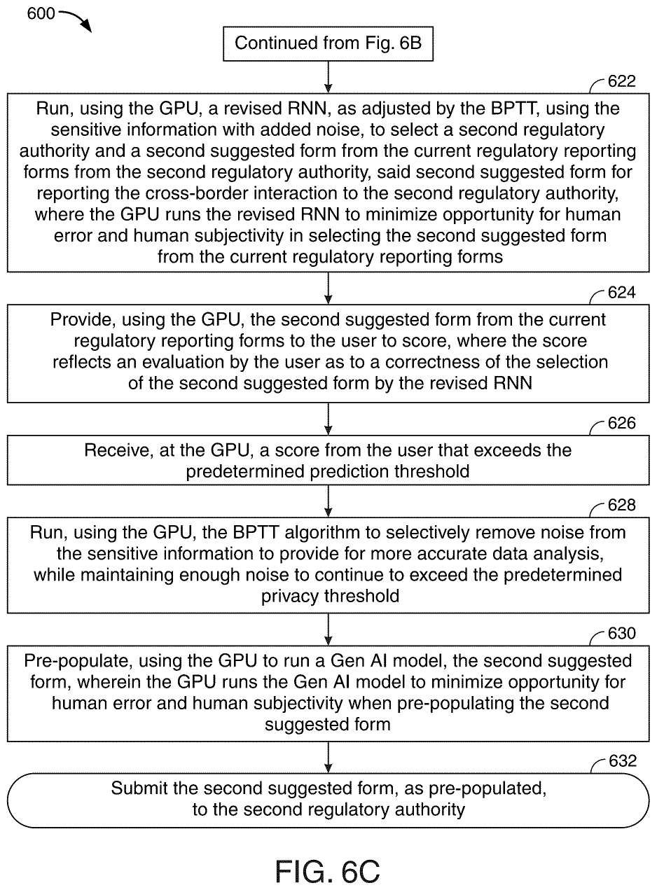

FIG. 6A shows an illustrative flow diagram 600 in accordance with the principles of the disclosure. Flow diagram 600 may begin with step 602. Step 602 may teach a method for automating submission of a regulatory reporting form to meet a regulatory reporting obligation for a cross-border interaction, where automation reduces the number of manual steps, thereby minimizing opportunity for human error and subjectivity.

Step 604 may teach a GPU receiving a request from a user to an organization for a most suitable regulatory reporting form (“suggested form”) relating to a cross-border interaction between the user and a second party that is facilitated by the organization. Each party may be governed by different regulatory reporting rules regarding the cross-border interaction. The suggested form may include a form that best meets the regulatory reporting obligation of the user from regulatory reporting forms available.

Step 606 may teach the GPU receiving sensitive information that includes information relating to the user, to a need of the user for the suggested form, to a location of the user, or combinations thereof. Step 608 may teach using the GPU to send one or more API requests to API endpoints of one or more regulatory authorities from one or more regions. The one or more regulatory authorities may be selected by the GPU based on legal locations or physical locations of the user and the second party at the time of the cross-border interaction, where the API requests for obtaining current regulatory reporting forms and current rules relating to the current regulatory reporting forms.

Step 610 may teach the GPU receiving from the one or more regulatory authorities in one or more regions, in response to the one or more API requests, current regulatory reporting forms and current rules relating to the current regulatory reporting forms relating to the cross-border interaction between the user and the second party. The process may continue with FIG. 6B.

FIG. 6B shows an illustrative flow diagram 600 in accordance with the principles of the disclosure. Flow diagram 600 may continue with step 612. Step 612 may teach using the GPU to run a DP algorithm to add noise to the sensitive information such that the noise obscures the sensitive information to exceed a predetermined privacy threshold while maintaining sufficient data structure within the sensitive information to facilitate data analysis.

Step 614 may teach using the GPU to run an RNN, using the sensitive information with added noise, to select a first regulatory authority and a first suggested form from the current regulatory reporting forms from the first regulatory authority. The first suggested form reports the cross-border interaction to the first regulatory authority. The GPU may run the RNN to minimize opportunity for human error and human subjectivity in selecting the first suggested form from the current regulatory reporting forms.

Step 616 may teach using the GPU to provide the first suggested form from the current regulatory reporting forms to the user to score. The score may reflect an evaluation by the user as to a correctness of the selection of the first suggested form by the RNN.

Step 618 may teach using the GPU to receive a score from the user that falls below the predetermined prediction threshold. Step 620 may teach using the GPU to run a BPTT algorithm to adjust the RNN. The output of adjusting the RNN is a revised RNN. The process may continue with FIG. 6C.

FIG. 6C shows an illustrative flow diagram 600 in accordance with the principles of the disclosure. Step 622 may teach using the GPU to run a revised RNN, as adjusted by the BPTT, and using the sensitive information with added noise to select a second regulatory authority and a second suggested form from the current regulatory reporting forms from the second regulatory authority. The second regulatory authority may be a different regulatory authority than the first regulatory authority. The second regulatory authority may be the same regulatory authority as the first regulatory authority. The second suggested form may be used to report cross-border interaction to the second regulatory authority. The GPU may be used to run the revised RNN to minimize opportunity for human error and human subjectivity in selecting the second suggested form from the current regulatory reporting forms.

Step 624 may teach using the GPU to provide the second suggested form from the current regulatory reporting forms to the user to score. The score may reflect an evaluation by the user as to a correctness of the selection of the second suggested form by the revised RNN. Step 626 may teach the GPU receiving the score from the user, where the score exceeds the predetermined prediction threshold.

Step 628 may teach using the GPU to run the BPTT algorithm to selectively remove noise from the sensitive information. Selectively removing noise may provide for more accurate data analysis. When the noise is removed judiciously, enough noise may be maintained to continue to exceed the predetermined privacy threshold.

Step 630 may teach using the GPU to run a Gen AI model to pre-populate the second suggested form. The GPU may run the Gen AI model to minimize opportunity for human error and human subjectivity when pre-populating the second suggested form. Step 632 may teach submission of the second suggested form, as pre-populated, to the second regulatory authority. The GPU may submit the second suggested form to the regulatory authority. The user may submit the second suggested form to the regulatory authority.

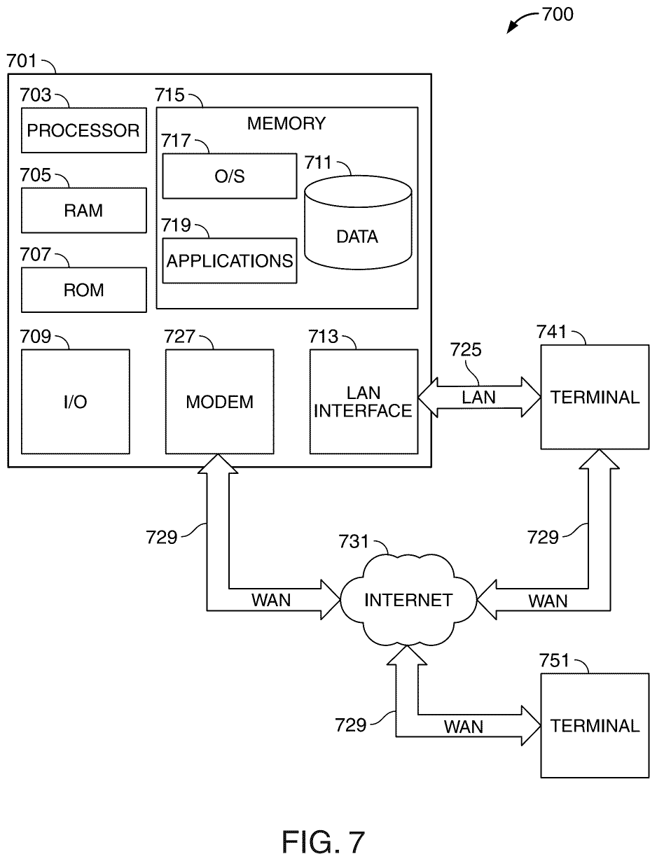

FIG. 7 shows an illustrative block diagram of system 700 that includes computer 701. Computer 701 may alternatively be referred to herein as an “engine,” “server” or a “computing device.” Computer 701 may be a workstation, desktop, laptop, tablet, smartphone, or any other suitable computing device. Elements of system 700, including computer 701, may be used to implement various aspects of the systems and methods disclosed herein, including those shown in FIGS. 1-6. Each of the systems, methods, and algorithms illustrated in FIGS. 1-6 may include some or all the elements of system 700.

Computer 701 may have a processor 703, including a central processing unit (“CPU”), for controlling the operation of the device and its associated components, and may include RAM 705, ROM 707, input/output (“I/O”) 709, and a non-transitory or non-volatile memory 715. Machine-readable memory may be configured to store information in machine-readable data structures. Processor 703 may also execute all software running on the computer. Other components, such as graphics processing unit (“GPU”), EEPROM, Flash memory, neural-network processing elements, or any other suitable components, may also be part of the computer 701.

Memory 715 may be comprised of any suitable permanent storage technology, such as a hard drive. Memory 715 may store software including the operating system 717 and application program(s) 719 along with any data 711 needed for the operation of system 700. Memory 715 may also store videos, text, and/or audio assistance files. The data stored in memory 715 may also be stored in cache memory, or any other suitable memory.

I/O module 709 may include connectivity to a microphone, keyboard, touch screen, mouse, and/or stylus through which input may be provided into computer 701. The input may include input relating to cursor movement. The input/output module may also include one or more speakers for providing audio output and a video display device for providing textual, audio, audiovisual, and/or graphical output. The input and output may be related to computer application functionality.

System 700 may be connected to other systems via a local area network interface 713. System 700 may operate in a networked environment supporting connections to one or more remote computers, such as terminals 741 and 751. Terminals 741 and 751 may be personal computers or servers that include many, or all the elements described above relative to system 700. The network connections depicted in FIG. 7 include a local area network (“LAN”) 725 and a wide area network (“WAN”) 729 but may also include other networks. When used in a LAN networking environment, computer 701 is connected to LAN 725 through LAN interface 713 or an adapter. When used in a WAN networking environment, computer 701 may include a modem 727 or other means for establishing communications over WAN 729, such as Internet 731.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration to permit retrieval of data from a web-based server or an API. Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 719, which may be used by computer 701, may include computer executable instructions for invoking functionality related to communication, such as e-mail, Short Message Service (“SMS”), and voice input and speech recognition applications. Application program(s) 719 (which may be alternatively referred to herein as “plugins,” “applications,” or “apps”) may include computer executable instructions for invoking functionality related to performing various tasks. Application program(s) 719 may utilize one or more algorithms that process receive executable instructions, perform power management routines or other suitable tasks.

Application program(s) 719 may include computer executable instructions (alternatively referred to as “programs”). The computer executable instructions may be embodied in hardware or firmware (not shown). Computer 701 may execute the instructions embodied by the application program(s) 719 to perform various functions.

Application program(s) 719 may utilize the computer-executable instructions executed by a processor. Programs may include routines, programs, objects, components, data structures, and the like, which perform tasks or implement abstract data types. A computing system may be operational with distributed computing environments. Tasks may be performed by remote processing devices that are linked through a communications network. In a distributed computing environment, a program may be in both local and remote computer storage media including memory storage devices. Computing systems may rely on a network of remote servers hosted on the Internet to store, manage, and process data (e.g., “cloud computing” and/or “fog computing”).

Any information described above in connection with data 711, and any other suitable information, may be stored in memory 715.

The disclosure may be described in the context of computer-executable instructions, such as application(s) 719, being executed by a computer. Programs may include routines, programs, objects, components, data structures, and the like, which perform tasks or implement data types. The computer-executable instructions may be located on one or more non-transitory computer-readable media. The computer-executable instructions, when executed by processor 703, may be used to implement various aspects of the systems and methods disclosed herein.

The disclosure may also be practiced in distributed computing environments. Tasks may be performed by remote processing devices that are linked through a communications network. A communications network may include a computer network. In a distributed computing environment, programs may be in both local and remote computer storage media including memory storage devices. It should be noted that such programs may be considered for the purposes of this application as engines with respect to the performance of the tasks to which the programs are assigned.

Computer 701 and/or terminals 741 and 751 may also include various other components, such as a battery, speaker, and/or antennas (not shown). Components of computer system 701 may be linked by a system bus, wirelessly or by other suitable interconnections. Components of computer system 701 may be present on one or more circuit boards. In some embodiments, the components may be integrated into a single chip. The chip may be silicon-based.

Terminal 741 and/or terminal 751 may be portable devices such as a laptop, cell phone, tablet, smartphone, or any other computing system for receiving, storing, transmitting, and/or displaying relevant information. Terminal 741 and/or terminal 751 may be one or more user devices. Terminals 741 and 751 may be identical to system 700 or different. Differences may be related to hardware components and/or software components.

The disclosure may be operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, tablets, mobile phones, smartphones and/or other personal digital assistants (“PDAS”), multiprocessor systems, microprocessor-based systems, cloud-based systems, programmable consumer electronics, network PCs, minicomputers, mainframe computers, distributed computing environments that include any of the above systems or devices, and the like.

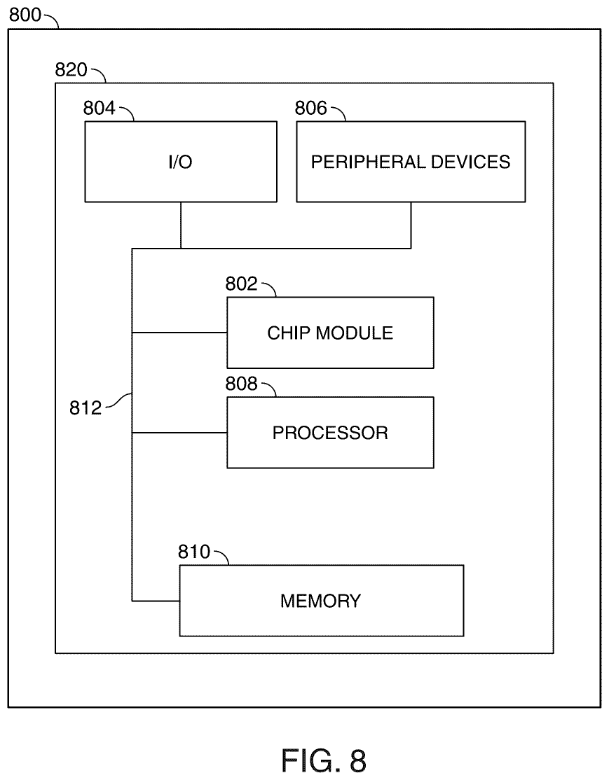

FIG. 8 shows an illustrative system 800 that may be configured in accordance with the principles of the disclosure. System 800 may be a computing device. System 800 may include one or more features of the apparatus shown in FIGS. 1-7. System 800 may include chip module 802, that may include one or more integrated circuits, and that may include logic configured to perform any other suitable logical operations.

System 800 may include one or more of the following components: I/O circuitry 804, that may include a transmitter device and a receiver device and may interface with fiber optic cable, coaxial cable, telephone lines, wireless devices, PHY layer hardware, a keypad/display control device or any other suitable media or devices; peripheral devices 806, that may include counter timers, real-time timers, power-on reset generators or any other suitable peripheral devices; logical processing device 808, that may compute data structural information and structural parameters of the data; and machine-readable memory 810.

Machine-readable memory 810 may be configured to store in machine-readable data structures: machine executable instructions, (which may be alternatively referred to herein as “computer instructions” or “computer code”), applications such as applications 719 (shown in FIG. 7), signals, and/or any other suitable information or data structures.

A system bus or other interconnections 812 may couple components 802, 804, 806, 808 and 810 and may be present on one or more circuit boards such as circuit board 820. In some embodiments, a single chip may integrate the components. The chip may be silicon-based.

Elements of system 800, including circuit board 820 and various coupled components found on circuit board 830, may be used to implement various aspects of the systems and methods disclosed herein, including those shown in FIGS. 1-7. Each of the systems and methods illustrated in FIGS. 1-7 may include some or all the elements of system 800.

Thus, provided may include systems and methods relating to using a recurrent neural network to automatically provide a regulatory reporting filing for a cross-border interaction. Aspects of this disclosure may further relate to using generative artificial intelligence to pre-populate the selected regulatory reporting filing. People skilled in the art will appreciate that the present invention can be practiced by other than the described embodiments, which are presented for purposes of illustration rather than of limitation. The present invention is limited only by the claims that follow.

1. A method for automating submission of a regulatory reporting form to meet a regulatory reporting obligation for a cross-border interaction, where automation reduces manual steps and thereby minimizes opportunity for human error and subjectivity, the method comprising:
receiving, at a graphics processing unit (“GPU”), a request from a user to an organization for a most suitable regulatory reporting form (“suggested form”) relating to a cross-border interaction, wherein:
the cross-border interaction comprises an interaction between the user and a second party that is facilitated by the organization;
the user and the second party are located in separate regions governed by separate regulatory reporting obligations relating to the cross-border interaction; and
the suggested form comprises a form that best meets the regulatory reporting obligation of the user from regulatory reporting forms available;
receiving, at the GPU, sensitive information to aid in determining which regulatory authority governs the user during the interaction between the user and the second party, said sensitive information comprising information relating to the user, to a need of the user for the suggested form, to a location of the user, or combinations thereof;
sending, using the GPU, one or more application programming interface (“API”) requests to API endpoints of one or more regulatory authorities from one or more regions, said one or more regulatory authorities are selected by the GPU based on legal locations or physical locations of the user and the second party when the cross-border interaction between the user and the second party occurs, said one or more API requests for obtaining current regulatory reporting forms and current rules relating to the current regulatory reporting forms;
receiving, at the GPU, from the one or more regulatory authorities in one or more regions, in response to the one or more API requests, current regulatory reporting forms and current rules relating to the current regulatory reporting forms relating to the cross-border interaction between the user and the second party;
running, using the GPU, a differential privacy (“DP”) algorithm to add noise to the sensitive information such that the noise obscures the sensitive information to exceed a predetermined privacy threshold while maintaining sufficient data structure within the sensitive information to facilitate data analysis;
running, using the GPU and the sensitive information with added noise, a recurrent neural network (“RNN”) to select a first regulatory authority and a first suggested form from the current regulatory reporting forms from the first regulatory authority, where said first suggested form serves to report the cross-border interaction to the first regulatory authority;
wherein the GPU runs the RNN to minimize opportunity for human error and human subjectivity in selecting the first suggested form from the current regulatory reporting forms;
providing, using the GPU, the first suggested form from the current regulatory reporting forms to the user to score;
wherein the score reflects an evaluation by the user as to a correctness of the selection of the first suggested form by the RNN;
receiving, at the GPU, a first score from the user that falls below a predetermined prediction threshold;
in response to receiving the first score, running, using the GPU, a backpropagation through time (“BPTT”) algorithm to adjust the RNN;
running, using the GPU and the sensitive information with added noise, a revised RNN as adjusted by the BPTT algorithm to select a second regulatory authority and a second suggested form from the current regulatory reporting forms from the second regulatory authority, said second suggested form for reporting the cross-border interaction to the second regulatory authority;
wherein the GPU runs the revised RNN to minimize opportunity for human error and human subjectivity in selecting the second suggested form from the current regulatory reporting forms;
providing, using the GPU, the second suggested form from the current regulatory reporting forms to the user to score;
wherein the score reflects an evaluation by the user as to a correctness of the selection of the second suggested form by the revised RNN;
receiving, at the GPU, a second score from the user that exceeds the predetermined prediction threshold;
in response to receiving the second score, running, using the GPU, the BPTT algorithm to adjust one or more privacy parameters of the DP algorithm to selectively remove noise from the sensitive information, thereby balancing data accuracy and privacy;
pre-populating, using the GPU to run a generative artificial intelligence (“Gen AI”) model, the second suggested form, wherein the GPU runs the Gen AI model to minimize opportunity for human error and human subjectivity when pre-populating the second suggested form; and
submitting the second suggested form, as pre-populated, to the second regulatory authority.

2. The method of claim 1 wherein the first regulatory authority and the second regulatory authority are separate regulatory authorities.

3. The method of claim 1 wherein the first regulatory authority comprises the second regulatory authority.

4. The method of claim 1 wherein the most suitable regulatory reporting form reflects the current rules relating to the current regulatory reporting forms for a region in which the user is located.

5. The method of claim 1 wherein:
the one or more regulatory authorities are selected by the GPU based on a legal location of the user and a legal location of the second party;
the legal location of the user comprises where the user has a domicile when the cross-border interaction occurs with the second party;
the legal location of the second party comprises where the second party has a domicile when the cross-border interaction occurs with the user; and
the legal location of the user is under a different regulatory authority than the legal location of the second party.

6. The method of claim 1 wherein:
the one or more regulatory authorities are selected by the GPU based on a physical location of the user and a physical location of the second party;
the physical location of the user comprises where the user has a domicile when the cross-border interaction occurs with the second party;
the physical location of the second party comprises where the second party has a domicile when the cross-border interaction occurs with the user; and
the physical location of the user is under a different regulatory authority than the physical location of the second party.

7. The method of claim 1 wherein each API endpoint comprises a unique uniform resource locator (“URL”).

8. The method of claim 1 wherein the step of submitting the second suggested form to the second regulatory authority is performed by the user.

9. The method of claim 1 wherein the step of submitting the second suggested form to the second regulatory authority is performed by the GPU.

10. A system for automation of submission of a regulatory reporting form to meet a regulatory reporting obligation for a cross-border interaction, where automation reduces manual steps and thereby minimizes opportunity for human error and subjectivity, the system comprising:
a graphic processing unit (“GPU”);
a recurrent neural network (“RNN”);
a generative artificial intelligence (“Gen AI”) model;
said GPU configured to:
receive a request from a user to an organization for a most suitable regulatory reporting form (“suggested form”) relating to a cross-border interaction, wherein:
the cross-border interaction comprises an interaction between the user and a second party that is facilitated by the organization;
the user and the second party are located in separate regions governed by separate regulatory reporting obligations relating to the cross-border interaction; and
the suggested form comprises a form that best meets the regulatory reporting obligation of the user from regulatory reporting forms available;
receive sensitive information to aid in determining which regulatory authority governs the user during the interaction between the user and the second party, said sensitive information comprising information relating to the user, to a need of the user for the suggested form, to a location of the user, or a combination thereof;
send one or more application programming interface (“API”) requests to API endpoints of one or more regulatory authorities from one or more regions, said one or more regulatory authorities are selected by the GPU based on legal locations or physical locations of the user and the second party when the cross-border interaction between the user and the second party occurs, said one or more API requests for obtaining current regulatory reporting forms and current rules relating to the current regulatory reporting forms;
receive from the one or more regulatory authorities from one or more regions, in response to the one or more API requests, current regulatory reporting forms and current rules relating to the current regulatory reporting forms relating to the cross-border interaction between the user and the second party;
run a differential privacy (“DP”) algorithm to add noise to the sensitive information such that the noise obscures the sensitive information to exceed a predetermined privacy threshold while maintaining sufficient data structure within the sensitive information to facilitate data analysis;
run the RNN, using the sensitive information with added noise, to select a first regulatory authority and a first suggested form from the current regulatory reporting forms from the first regulatory authority, where said first suggested form serves to report the cross-border interaction to the first regulatory authority;
wherein the GPU runs the RNN to minimize opportunity for human error and human subjectivity in selecting the first suggested form from the current regulatory reporting forms;
provide the first suggested form from the current regulatory reporting forms to the user to score;
wherein the score reflects an evaluation by the user as to a correctness of the selection of the first suggested form by the RNN;
receive a first score from the user that falls below a predetermined prediction threshold;
in response to receiving the first score, run a backpropagation through time (“BPTT”) algorithm to adjust the RNN;
run a revised RNN as adjusted by the BPTT algorithm, using the sensitive information with added noise, to select a second regulatory authority and a second suggested form from the current regulatory reporting forms from the second regulatory authority, said second suggested form for reporting the cross-border interaction to the second regulatory authority;
wherein the GPU runs the revised RNN to minimize opportunity for human error and human subjectivity in selecting the second suggested form from the current regulatory reporting forms;
provide the second suggested form from the current regulatory reporting forms to the user to score;
wherein the score reflects an evaluation by the user as to a correctness of the selection of the second suggested form by the revised RNN;
receive a second score from the user that exceeds the predetermined prediction threshold;
in response to receiving the second score, run the BPTT algorithm to adjust one or more privacy parameters of the DP algorithm to selectively remove noise from the sensitive information, thereby balancing data accuracy and privacy;
pre-populate, by use of the Gen AI model, the second suggested form, wherein the GPU runs the Gen AI model to minimize opportunity for human error and human subjectivity when pre-populating the second suggested form; and
submit the second suggested form, as pre-populated, to the second regulatory authority;
wherein the second regulatory authority is where the second suggested form was obtained.

11. The system of claim 10 wherein the first regulatory authority and the second regulatory authority are separate regulatory authorities.

12. The system of claim 10 wherein the first regulatory authority comprises the second regulatory authority.

13. The system of claim 10 wherein the most suitable regulatory reporting form reflects the current rules relating to said current regulatory reporting forms for a region in which the user is located.

14. The system of claim 10 wherein:
the one or more regulatory authorities are selected by the GPU based on a legal location of the user and a legal location of the second party;
the legal location of the user comprises where the user has a domicile when the cross-border interaction occurs with the second party;
the legal location of the second party comprises where the second party has a domicile when the cross-border interaction occurs with the user; and
the legal location of the user is under a different regulatory authority than the legal location of the second party.

15. The system of claim 10 wherein:
the one or more regulatory authorities are selected by the GPU based on a physical location of the user and a physical location of the second party;
the physical location of the user comprises where the user has a domicile when the cross-border interaction occurs with the second party;
the physical location of the second party comprises where the second party has a domicile when the cross-border interaction occurs with the user; and
the physical location of the user is under a different regulatory authority than the physical location of the second party.

16. The system of claim 10 wherein each API endpoint comprises a unique uniform resource locator (“URL”).

17. A system for automation of submission of a regulatory reporting form to meet a regulatory reporting obligation for a cross-border interaction, where automation reduces manual steps and thereby minimizes opportunity for human error and subjectivity, the system comprising:
a graphic processing unit (“GPU”);
a recurrent neural network (“RNN”);
a generative artificial intelligence (“Gen AI”) model;
said GPU configured to:
receive a request from a user to an organization for a most suitable regulatory reporting form (“suggested form”) relating to a cross-border interaction, wherein:
the cross-border interaction comprises an interaction between the user and a second party that is facilitated by the organization;
the user and the second party are located in separate regions governed by separate regulatory reporting obligations relating to the cross-border interaction; and
the suggested form comprises a form that best meets the regulatory reporting obligation of the user from regulatory reporting forms available;
receive sensitive information to aid in determining which regulatory authority governs the user during the interaction between the user and the second party, said sensitive information comprising information relating to the user, to a need of the user for the suggested form, to a location of the user, or a combination thereof;
send one or more application programming interface (“API”) requests to API endpoints of one or more regulatory authorities in one or more regions, said API endpoints each comprising a unique uniform resource locator (“URL”), said one or more regulatory authorities are selected by the GPU based on legal locations or physical locations of the user and the second party when the cross-border interaction between the user and the second party occurs, said one or more API requests for obtaining current regulatory reporting forms and current rules relating to the current regulatory reporting forms;
receive from the one or more regulatory authorities from one or more regions, in response to the one or more API requests, current regulatory reporting forms and current rules relating to the current regulatory reporting forms relating to the cross-border interaction between the user and the second party;
run a differential privacy (“DP”) algorithm to add noise to the sensitive information such that the noise obscures the sensitive information to exceed a predetermined privacy threshold while maintaining sufficient data structure within the sensitive information to facilitate data analysis;
run the RNN, using the sensitive information with added noise, to select a first regulatory authority and a first suggested form from the current regulatory reporting forms from the first regulatory authority, where said first suggested form serves to report the cross-border interaction to the first regulatory authority;
wherein the GPU runs the RNN to minimize opportunity for human error and human subjectivity in selecting the first suggested form from the current regulatory reporting forms;
provide the first suggested form from the current regulatory reporting forms to the user to score;
wherein the score reflects an evaluation by the user as to a correctness of the selection of the first suggested form by the RNN;
receive a first score from the user that falls below a predetermined prediction threshold;
in response to receiving the first score, run a backpropagation through time (“BPTT”) algorithm to adjust the RNN;
run a revised RNN as adjusted by the BPTT algorithm, using the sensitive information with added noise, to select a second regulatory authority and a second suggested form from the current regulatory reporting forms from the second regulatory authority, said second suggested form for reporting the cross-border interaction to the second regulatory authority;
wherein the GPU runs the revised RNN to minimize opportunity for human error and human subjectivity in selecting the second suggested form from the current regulatory reporting forms;
provide the second suggested form from the current regulatory reporting forms to the user to score;
wherein the score reflects an evaluation by the user as to a correctness of the selection of the second suggested form by the revised RNN;
receive a second score from the user that exceeds the predetermined prediction threshold;
in response to receiving the second score, run the BPTT algorithm to adjust one or more privacy parameters of the DP algorithm to selectively remove noise from the sensitive information, thereby balancing data accuracy and privacy;
pre-populate, by use of the Gen AI model, the second suggested form, wherein the GPU runs the Gen AI model to minimize opportunity for human error and human subjectivity when pre-populating the second suggested form; and
provide pre-populated second suggested form to the user for submission to the second regulatory authority;
wherein the second regulatory authority is where the second suggested form was obtained.

18. The system of claim 17 wherein the most suitable regulatory reporting form reflects the current rules relating to said current regulatory reporting forms for a region in which the user is located.

19. The system of claim 17 wherein:
the one or more regulatory authorities are selected by the GPU based on a legal location of the user and a legal location of the second party;
the legal location of the user comprises where the user has a domicile when the cross-border interaction occurs with the second party;
the legal location of the second party comprises where the second party has a domicile when the cross-border interaction occurs with the user; and
the legal location of the user is under a different regulatory authority than the legal location of the second party.

20. The system of claim 17 wherein:
the one or more regulatory authorities are selected by the GPU based on a physical location of the user and a physical location of the second party;
the physical location of the user comprises where the user has a domicile when the cross-border interaction occurs with the second party;
the physical location of the second party comprises where the second party has a domicile when the cross-border interaction occurs with the user; and
the physical location of the user is under a different regulatory authority than the physical location of the second party.
